(19) United States
(12) Patent Application Publication
(10) Pub. No.: US 2015/0052727 A1
(43) Pub. Date: Feb. 26, 2015

(54) Medicine cabinet organizing system

(71) Applicant: Robert Michael Rosso, JR., Costa Mesa, CA (US)

(72) Inventor: Robert Michael Rosso, JR., Costa Mesa, CA (US)

(21) Appl. No.: 13/972,628

(22) Filed: Aug. 21, 2013

(51) Int. Cl. F16M 13/02

(52) U.S. Cl. CPC F16M 13/02
USPC 29/428; 248/206.5

(57) ABSTRACT

A medicine cabinet organizing system suspends products to the undersides of cabinet shelves. Products may be individually held by clips that include a ferromagnetic material. The clips in turn couple to magnets attached to the underside of the shelves. Magnets may move with respect to the shelves to allow storage of different size products. An organizing system kit includes a plate having a ferromagnetic material, a fastener to affix the plate to the cabinet shelf, two or more bar magnets, and a plurality of clips, each clip including a ferromagnetic material and a spring element.

### BACKGROUND

This invention is in the field of storage of products for convenient access, particularly within medicine cabinets.

Products commonly stored in medicine cabinets have diverse sizes and shapes and are intended to be held in the hand. Toothpaste, for example, is sold in elongated tubes with a round cap at one end and a flattened bond at the opposite end; deodorant is available in roughly cylindrical containers; razors are irregularly shaped. Toothbrushes are narrow while toiletry containers can be broad.

A product intended to be held in one hand is most readily grasped if oriented with its long axis vertically. This allows easy pick up with the long axis traversing the palm. However such products are less stable if stored in an upright position—they can tip over if jostled. In a medicine cabinet with narrow shelves, tipping over often means a product falls out of the cabinet to counter or floor. This risks product breakage and causes inconvenience to pick up and replace the product.

Many personal-use products are elongated with a handle end and an opposed application or business end. Some such products are broader at the business end; others are broader at the handle end. Since products do not readily stand on their narrower ends, some products are stored in the reverse orientation from the way they are held during use. Further, medicine cabinets do not make efficient use of storage space. The space immediately above a shelf tends to be crowded with the broader ends of products, but less space is used higher up because product upper ends may be narrower and some products may be shorter than the shelf spacing.

My invention addresses these and other problems by allowing efficient packing of cabinets without risk of products falling. The invention supports products of different sizes in easily graspable orientations.

### SUMMARY

My invention includes a medicine cabinet organizing system that suspends products to the undersides of medicine cabinet shelves. Products may be individually held by clips that include a ferromagnetic material. The clips in turn couple to magnets attached to the underside of the shelves. Magnets may move with respect to the shelves to allow storage of different size products.

My invention also includes a method for retaining products to a shelf including steps of attaching magnets to shelves, gripping products individually with clips, and suspending the gripped products magnetically by the clips.

In some embodiments, my invention includes a system for suspending diverse-sized products to a shelf of a medicine cabinet having a first magnet configured to attach to the underside of the shelf at a first position. A second magnet may be configured to movably attach to the underside of the shelf at a second position or at a third position, where the third position is spatially separated from the first position and the second position intermediate the first position and the third position. The embodiment also includes a first clip for gripping a first product, a second clip for gripping a second product, and a third clip for gripping a third product, where the third product is of different size from the second product. The first magnet suspends the first product at the first position via the first clip, and the second magnet suspends either the second product at the second position clip via the second clip or the third product at the third position via the third clip.

In some embodiments, a plate including a ferromagnetic material may span the distance between the first position and the third position. The plate may be affixed to the underside of the shelf with the first magnet and the second magnet attached to the plate.

In other embodiments, a method for retaining product to a shelf includes attaching a first magnet to the underside of the shelf at a first position and attaching a second magnet to the underside of the shelf at a second position. The embodiment also includes gripping a first product with a first clip, gripping a second product with a second clip, and gripping a third product with a third clip. Additional steps include suspending the first clip from the first magnet, suspending the second clip from the second magnet, and removing the second clip from the second magnet. The embodiment further includes moving the second magnet to a third position on the underside of the shelf, where the third position is spatially separated from the second position, and suspending the third clip from the second magnet.

In some embodiments, the method may include affixing to the underside of the shelf a plate including a ferromagnetic material, where the plate spans the distance between the first position and the third position. The first magnet and the second magnet may be attached to the plate to indirectly suspend the products from the shelf.

In still other embodiments, the invention includes a kit for suspending products to a shelf of a medicine cabinet. The kit includes a plate having a ferromagnetic material, a fastener to affix the plate to the shelf, two or more bar magnets, and a plurality of clips. Each clip has a ferromagnetic material and a spring element. In some embodiments, the clips may be binder clips of at least two different sizes to suspend different size products.

### BRIEF DESCRIPTION OF THE DRAWINGS

FIG. 1 illustrates a medicine cabinet containing products and including several embodiments of the storage system of my invention.

FIG. 2 illustrates a larger view of one of the embodiments of FIG. 1 shown holding a number of products.

FIG. 3 illustrates an embodiment of the plate of the invention without clips or products.

FIG. 4 illustrates an open binder clip useful in some embodiments.

### DETAILED DESCRIPTION

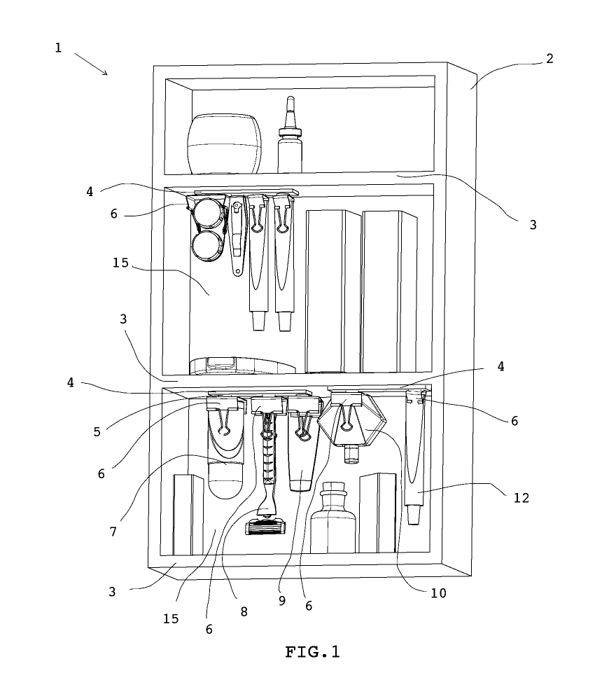

FIG. 1 illustrates a medicine cabinet containing products and including several embodiments of the storage system 1 of my invention. Cabinet 2 is oriented vertically in FIG. 1 as in use. Cabinet 2 includes multiple shelves 3 separated by spaces 15. Upper surfaces of shelves 3 support various products in a conventional manner; products rest upon and are supported by shelves 3.

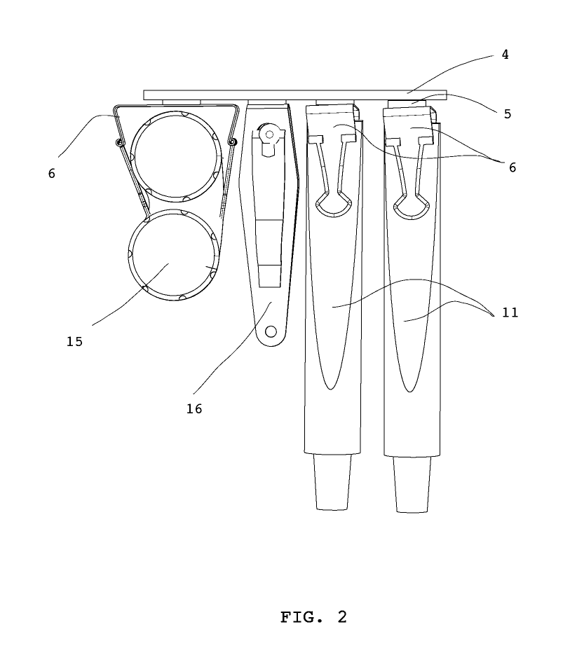

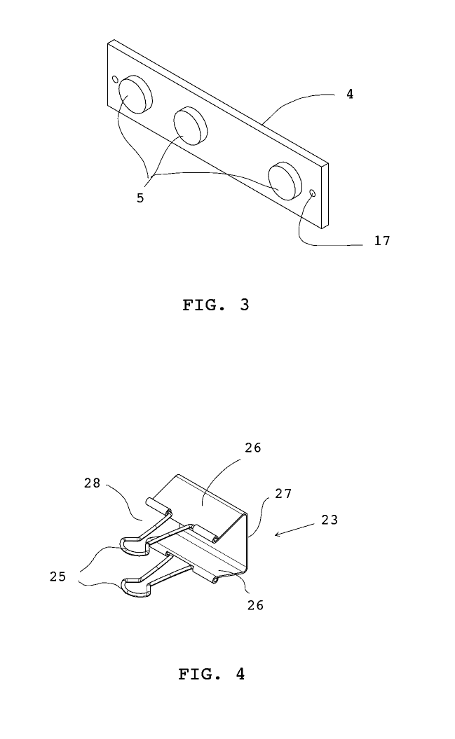

The lower aspects of two of shelves 3 also support products, but these depend downwardly from the shelves. Affixed at selected locations to the lower aspects of shelves 3 are plates 4; FIG. 1 shows three instances. Each plate 4 has attached a plurality of magnets 5 (best visible in FIGS. 2 and 3). Magnets 5 in turn suspend clips 6, and clips 6 individually grip one of products 7-13 so that products 7-13 are indirectly suspended from the lower aspects of shelves 3.

Plates 4 include ferromagnetic materials capable of coupling to magnets. Plates 4 are elongated, and sized to fit within medicine cabinet 2. I have found it advantageous to form plates 4 with length less than about one half the lengths of shelves 3 as this makes it easier to affix plates 4 shelves 3 within the confined space of medicine cabinet 2. Further, the use of plates 4 with such lengths makes it possible to position two or more plates 4 at staggered depths at different positions along the length of a shelf 3. A staggered position may accommodate product of different sizes, particularly when product is not symmetrical in shape.

In some embodiments, (as illustrated in the lower of spaces 15 of FIG. 1) more than one plate 4 may affix to a single shelf 3. In other embodiments, a single plate 4 may affix to one shelf 3 (as illustrated in the middle space 15 of FIG. 1). Where more than one plate 4 affixes to one shelf 3, plates 4 may be placed at staggered depths in cabinet 2 (shown in FIG. 1 in lower of spaces 15 where left hand plate 4 is set back a greater distance from the front edge of shelf 3 than is the right hand plate 4). Alternatively, more than one plate 4 may affix to one shelf 3 such that the plates 4 overlap in extent (not illustrated) with one plate 4 closer to the front edge of shelf 3 and one set back a greater distance). In some embodiments the above alternatives may be combined in any compatible fashion. The benefit of this versatile positioning of plates 4 affixed to shelf 3 is to accommodate products of diverse or irregular size.

In some embodiments, the long axis of plates 4 runs parallel to shelves 3 (from left to right in FIG. 1). However plates 4 in other embodiments may be disposed in other orientations with respect to shelves 3, such as parallel to the shelf width (from front to back of cabinet 2) or at an angle with respect to the length of shelves 3. These alternatives afford the user the ability to customize his or her cabinet 2 to best fit with that users particular collection of products.

Plates 4 may be affixed to shelves 3 by any of a variety of techniques including the use of fasteners, adhesives, or through clamps integrally formed with plates 4. In some embodiments, plates 4 are affixed using screws. Plates 4 may include one or more mounting holes 17 to permit insertion of such screws.

In some embodiments, plates 4 may be absent because shelves 3 include ferromagnetic materials and are thus capable of coupling to magnets 5 directly.

Magnets 5 may be thin bar magnets. Bar magnets have opposite poles disposed on opposite, substantially flat ends of each part. The direction of magnetization is thus directed through the opposite ends giving greatest retention force to ferromagnetic materials coupled at the opposite ends. Bar magnets may have any shape. Magnets 5 are advantageously made thin to preserve vertical space. Magnets 5 may be formed as disks (as visible in FIG. 3) or as rectangles or as any other thin shape. In some embodiments, magnets 5 may be about ¼ inch to about 1 inch across and about 1/16 inch to about ¼ inch thick. Magnets 5 may be D62 disk magnets available from K&J Magnetics, Inc. of Pipersville, Pa.

Clips 6 serve to couple magnets 5 to products 7-13. Each clip 6 includes a ferromagnetic material and a gripping element. Ferromagnetic material may be steel and may advantageously also serve as part of the gripping element if it includes a spring steel.

The ferromagnetic element has a portion that contacts magnet 5 when in use. Advantageously, this portion is slightly curved so as to reduce the contact surface between magnet 5 and the portion of clip 6 that contacts magnet 5. Such a slight curvature decreases the contact area and hence the holding force between magnet 5 and clip 6. Thus when a user grasps product 7, and pulls it away from shelf 3, clip 6 will release from magnet 5 rather than magnet 5 releasing from plate 4. This has the advantage that desired spacing may be maintained simply by replacing product 7 with its attached clip 6 on magnet 5. There is no need to reattach clip 6 to product 7 because clip 6 need never be removed; product 7 is used with clip 6 still in place.

The gripping element of clip 6 that grips product 7 is desirably oriented in the opposite direction from the portion of clip 6 that contacts magnet 5. This has the benefit of orienting the product vertically beneath shelf 3. Many personal care products commonly stored in medicine cabinets are designed to be held in one hand during use. Such a product is most readily grasped if oriented with its long axis vertically. This allows easy pick up by the hand in a ready-to-use orientation.

The gripping element of clip 6 may be any of a variety of designs. Most rely on friction to grip product. Others may use encompassing features to retain product. Since products vary considerably in shape, friction type grippers are more generally applicable. Friction may be considerably increased by applying a spring or restoring force that impels the gripping feature against opposing portions of the product. In some embodiments, the gripping feature may include a nest of flexible tines or bristles. Product insertion separates the tines, and the tines in turn exert a restoring force holding the product.

In some embodiments (as illustrated in FIGS. 1 and 2), clip 6 includes a conventional binder clip 23. FIG. 4 shows binder clip 23 disposed in an open configuration to better display relationships. Binder clips 23 include a bent section of spring steel and a pair of wire handles 25. The spring steel is bent so that its cross section is substantially triangular with base 27, sides 26 and an opening 28 at its apex. Adjacent opening 28 the material of sides 26 is rolled to form cavities at either side into which wire handles 25 insert and freely rotate. FIG. 4 shows wire handles 25 rotated so that they are disposed away from base 27. Normally the spring force exerted by the bent steel keeps opening 28 closed. Binder clip 23 may be opened by disposing wire handles 25 so that they are adjacent sides 26 and pressing wire handles toward one another. Once binder clip 23 is opened in this manner, a product may be inserted into opening 28 and pressure released from wire handles 25. Opening 28 then closes over product, retaining it in binder clip 23. User may then rotate wire handles so as to dispose them in contact with product for easier gripping of the product binder clip combination. A user may remove a binder clip 23 from an exhausted product and reuse it on a new product.

Base 27 has a camber when an inserted product holds binder clip 23 partially open. This camber produces a concave surface on base 27 when viewed from the outside of binder clip 23. This concave surface provides the slight curvature described above; it decreases the contact area and hence the holding force between magnet 5 and binder clip 23.

Binder clips are commercially available at low cost in a wide range of sizes. By providing an assortment of different-sized binder clips as clips 6, an embodiment of the invention can support a diverse collection of product sizes and geometries.

As discussed, personal use products 7-13 may be of diverse size and shapes. Illustrated in FIGS. 1 and 2 for example are deodorant bottle 7, safety razor 8, toiletry bottle 9, perfume bottle 10, products packaged in squeeze tube such as first aid ointments 11 or toothpaste 12, contact lens holder 12 and nail clippers 16.

Certain objects made of ferromagnetic materials can suspend directly from magnets 5. For example, steel nail clippers 16 are held sufficiently by magnet 5 so that no clip is required.

FIG. 1 illustrates additional flexibility of my invention to store products. As discussed, products may differ as to height and width. Shelf spacing in medicine cabinets is generally not adjustable unless the entire shelf is moved. Thus a conventional medicine cabinet can make no well-organized use of space above a short product disposed on a shelf. My invention makes it possible to fill a cabinet space 15 both upwardly from the shelf below and downwardly from the space above, thus making better use of the space while still keeping each product accessible without moving others. Further, products suspended from the shelf above are positively retained by magnets 5. These suspended products are thus much less likely to be knocked over or out of the cabinet even if they are jostled.

In embodiments that include binder clips, binder clips may suspend from magnets in any orientation. That is the side of a binder clip may face outward, it may face left or right (in the FIG. 1 orientation), or it may face at some intermediate angle to best display the product and to save space.

My invention provides an additional benefit because magnets 5 are retained to plate 4 (and hence to shelf 3) only by magnetic attraction. This is advantageous because it means that the magnets may hold their position against casual jostling but nonetheless may be moved when desired. A user may slide a magnet from a first position to a second position or may remove and replace a magnet in a new position. This allows for the suspension of different sized products as they are acquired.

In addition, a user may add magnets in open spots of plate 4 to suspend additional products as desired.

In one method of using an embodiment of my invention, a user may change the storage organization from, for example, an arrangement with two closely spaced magnets holding relatively narrow products to one with widely spaced magnets where one magnet holds a wider product. A user accomplishes this simply by removing one of the narrow products and its clip from one of the magnets and moving the magnet to a new position on the plate. The user then suspends the wider product (with its own clip) from the moved magnet.

My invention also includes a kit for applying my storage system to existing cabinets. In some embodiments, such a kit contains a plate including a ferromagnetic material as described above and fasteners to affix the plate to a shelf, two or more bar magnets, which may be disk magnets, and a collection of binder clips of assorted sizes.

Any of the above described features and elements, though described in reference to a particular embodiment, may be combined with features and elements described for other embodiments without departing from the scope of the invention. The invention is not limited by the particular embodiments described in this specification but instead is defined solely according to the claims.

I claim:

1. A system for suspending diverse-sized products to a shelf of a medicine cabinet comprising:
a first magnet configured to attach to the underside of the shelf at a first position;
a second magnet configured to movably attach to the underside of the shelf at a second position or at a third position, the third position spatially separated from the first position and the second position intermediate the first position and the third position;
a first clip for gripping a first product; and
a second clip for gripping a second product;
a third clip for gripping a third product, the third product of different size from the second product,
wherein the first magnet suspends the first product at the first position via the first clip and the second magnet suspends either the second product at the second position clip via the second clip or the third product at the third position via the third clip.

2. The system of claim 1 further comprising a plate including a ferromagnetic material, the plate spanning the distance between the first position and the third position, the plate affixed to the underside of the shelf, and the first magnet and the second magnet attached to the plate.

3. The system of claim 2 wherein the plate is affixed to the shelf by fasteners or adhesives.

4. The system of claim 1 wherein the first clip includes a ferromagnetic material to couple to the first magnet and a spring element to grip the first product.

5. The system of claim 3 wherein the first clip is a binder clip.

6. A method of system for retaining product to a shelf, the method comprising:
attaching a first magnet to the underside of the shelf at a first position;
attaching a second magnet to the underside of the shelf at a second position;
gripping a first product with a first clip;
gripping a second product with a second clip;
gripping a third product with a third clip;
suspending the first clip from the first magnet;
suspending the second clip from the second magnet;
removing the second clip from the second magnet;
moving the second magnet to a third position on the underside of the shelf, the third position spatially separated from the second position; and
suspending the third clip from the second magnet.

7. The method of claim 5 further comprising affixing a plate to the underside of the shelf, wherein the plate spans the first position, the second position, and the third position.

8. The method of claim 5 wherein each of the first clip, the second clip, and the third clip include a ferromagnetic material.

9. The method of claim 7 wherein each of the first clip, the second clip, and the third clip include a spring element to grip respective first product, second product, and third product.

10. A kit for suspending products to a shelf of a medicine cabinet; the kit comprising
a plate including a ferromagnetic material;
a fastener to affix the plate to the shelf;
two or more bar magnets; and
a plurality of clips, each clip including a ferromagnetic material and a spring element.

11. The kit for of claim 10 wherein the plurality of clips comprise binder clips.

12. The kit of claim 11 where the plurality of clips includes clips of a plurality of sizes.

13. The kit of claim 12 wherein the bar magnets are cylindrical magnets.
